(19) United States
(12) Patent Application Publication
(10) Pub. No.: US 2015/0006281 A1
(43) Pub. Date: Jan. 1, 2015

(54) INFORMATION PROCESSOR, INFORMATION PROCESSING METHOD, AND COMPUTER-READABLE MEDIUM

(71) Applicant: CASIO COMPUTER CO, LTD., Tokyo (JP)

(72) Inventor: Nobuteru TAKAHASHI, Tokyo (JP)

(21) Appl. No.: 14/310,600

(22) Filed: Jun. 20, 2014

(30) Foreign Application Priority Data
Jun. 26, 2013 (JP) 2013-133262

(51) Int. Cl. G06Q 30/02

(52) U.S. Cl. CPC G06Q 30/0246
USPC 705/14.45

(57) ABSTRACT

The control unit of the digital signage device recognizes a person who is paying attention to a content, based on an image captured by the image-taking unit during reproduction of the content, and acquires image data and voice data of the person, and sends the data to the server device. The control unit of the server device analyzes the image data and the voice data received from the digital signage device, determines whether the reaction of the person paying attention to the content is categorized as positive or negative about the content, and counts the number of determinations that a reaction to the content is categorized as positive or negative, so that the control unit calculates a fee to be charged.

### BACKGROUND

1. Technical Field

The present invention relates to an information processor, an information processing method, and a computer-readable medium.

2. Related Art

It is generally known that advertising effect measuring devices are used for measuring effects of advertisements shown on displays. For example, there is disclosed an advertising effect measuring device that is capable of accurately measuring a visibility rate representing the proportion of people who viewed a display, by counting not only the number of people who viewed the display but also the number of people who were in front of the display (see, for example, JP 2011-210238 A).

The technology disclosed in JP 2011-210238 A, however, is disadvantageous in that it conducts the measuring without considering effects that advertising contents have had on viewers. More specifically, the technology does not consider whether advertising contents have given viewers positive feelings or negative feelings. Further, in a business model of advertising contents, advertising expenses are generally determined by time zones or locations for contents reproduction, not by effects that contents have exerted on viewers.

### SUMMARY

An object of the present invention is to achieve charging for contents based on effects that the contents have produced on viewers.

According to the present invention, there is provided an information processor, including:

a display unit configured to display a content;

an image-taking unit configured to take an image of a person who is in front of the display unit during display of the content;

a recognition unit configured to recognize a person who is paying attention to the content based on the image captured by the image-taking unit;

an acquisition unit configured to acquire reaction information indicating a reaction of the person paying attention to the content;

a determination unit configured to determine whether the reaction of the person paying attention to the content is categorized as positive or negative about the content, based on the reaction information; and

a fee calculation unit configured to calculate a fee to be charged for the content by counting the number of determinations made by the determination unit that a reaction to the content is categorized as positive or negative about the content.

The present invention makes it possible to set a price for a content based on effects that the content has produced on viewers

### BRIEF DESCRIPTION OF THE DRAWINGS

FIG. 1 is a diagram illustrating a whole configuration of a content charge system according to an embodiment of the present invention;

FIG. 2 is a block diagram illustrating a functional configuration of a digital signage device in FIG. 1;

FIG. 3 is a diagram illustrating a schematic configuration of a screen unit in FIG. 2;

FIG. 4 is a block diagram illustrating a functional configuration of a server device in FIG. 1;

FIG. 5A is a diagram illustrating an example of a positive/negative determination table;

FIG. 5B is a diagram illustrating an example of the positive/negative determination table;

FIG. 6 is a flowchart illustrating a reaction acquisition processing executed by a control unit in FIG. 2;

FIG. 7 is a flowchart illustrating an evaluation value calculation processing executed by a control unit in FIG. 4;

FIG. 8 is a flowchart illustrating charged fee calculation processing A executed by the control unit in FIG. 4;

FIG. 9 is a flowchart illustrating charged fee calculation processing B executed by the control unit in FIG. 4; and

FIG. 10 is a flowchart illustrating charged fee calculation processing C executed by the control unit in FIG. 4.

### DETAILED DESCRIPTION

A preferred embodiment of the present invention will be hereinafter described in detail with reference to accompanying drawings. It is to be noted that the present invention is not limited to the example shown in the drawings.

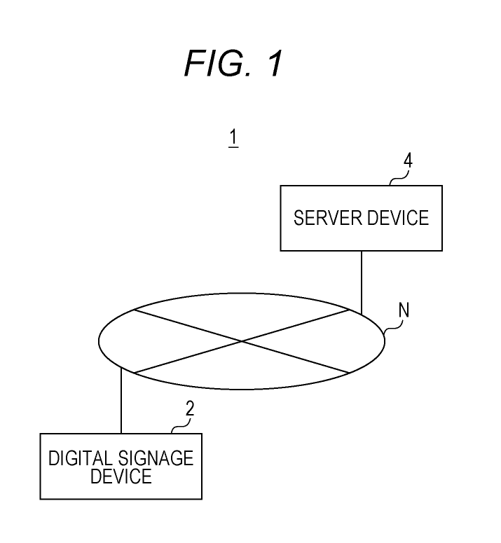

FIG. 1 is a block diagram illustrating a schematic configuration of a content charge system 1 according to an embodiment of the present invention. The content charge system 1 is a system that evaluates a content provided in response to a request from an advertiser and calculates a price to be charged for the content (on the advertiser) based on the evaluation. The content charge system 1 is provided with a digital signage device 2 and a server device 4 capable of communicating with the digital signage device 2 via a communication network N. The number of digital signage devices 2 to be provided is not particularly limited.

### [Digital Signage Device]

The digital signage device 2 is an information processor installed in a store, for example, and reproducing contents in response to a request from an advertiser.

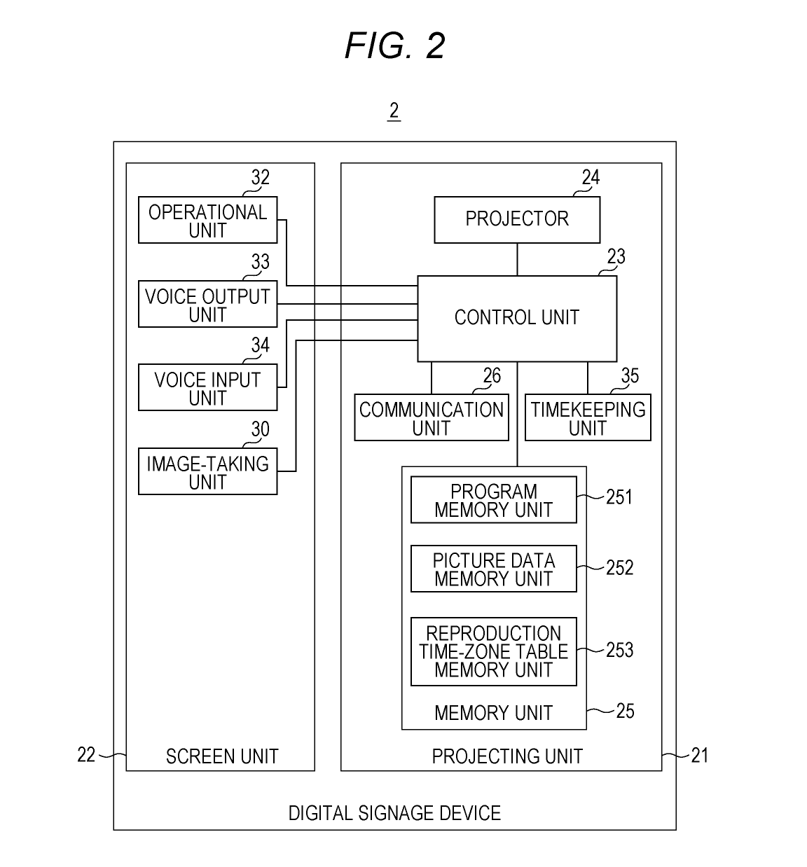

FIG. 2 is a block diagram illustrating a configuration of the main control of the digital signage device 2. The digital signage device 2 includes a projecting unit 21 and a screen unit 22. The projecting unit 21 emits a picture light of a content, and the screen unit 22 receives the picture light emitted from the projecting unit 21 at the back surface of the screen unit 22 and projects the picture light onto the front surface.

The projecting unit 21 will be described first.

The projecting unit 21 includes a control unit 23, a projector 24, a memory unit 25, a communication unit 26, and a timekeeping unit 35. The projector 24, the memory unit 25, the communication unit 26, and the timekeeping unit 35 are connected to the control unit 23 as shown in FIG. 2.

The control unit 23 includes a CPU (central processing unit) that performs predetermined operations and controls on different units through execution of various programs stored in the memory unit 25, and a memory to be a work area at the time of program execution (the CPU and the memory not shown in the drawings). The control unit 23 functions as a recognition unit.

The projector 24 converts image data of picture data output from the control unit 23 into picture light, and emits the picture light to the screen unit 22.

The memory unit 25 is formed of a HDD (hard disk drive) and a nonvolatile semiconductor memory, for example. The memory unit 25 includes a program memory unit 251, a picture data memory unit 252, and a reproduction time-zone table memory unit 253, as shown in FIG. 2.

The program memory unit 251 stores a system program to be executed in the control unit 23, various types of processing programs, and data necessary for execution of the programs, for example. The picture data memory unit 252 stores picture data of a content that the projecting unit 21 projects onto the screen unit 22. The picture data is composed of image data for a plurality of frame images forming video data, and voice data for each of the frame images. Although the picture data is supposed to have been distributed from the server device 4 in advance and be stored in the picture data memory unit 252, it may be distributed from the server device 4 every time it is to be reproduced.

The reproduction time-zone table memory unit 253 correlates contents with their respective identification data (content ID herein) for identifying the contents, and stores a table indicating a time period and a time zone where the picture data of each content is reproduced.

The communication unit 26 includes a modem, a router, a network card, etc. and communicates with external equipment such as the server device 4 on the communication network N.

The timekeeping unit 35 is formed of a RTC (real time clock), for example, and acquires information on current date and time and outputs the information to the control unit 23.

Next, the screen unit 22 will be described.

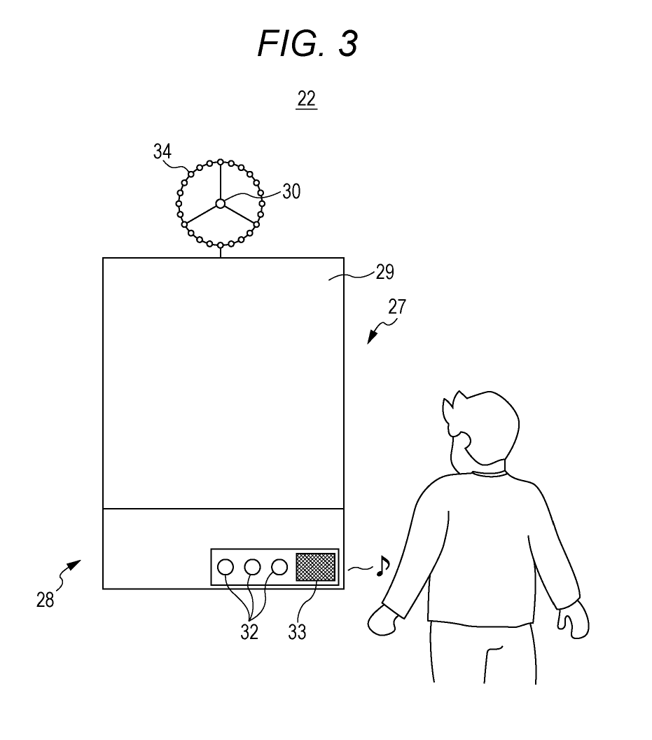

FIG. 3 is a front view illustrating a schematic configuration of the screen unit 22. As FIG. 3 shows, the screen unit 22 is provided with a square image forming unit 27 and a base 28 supporting the image forming unit 27.

The image forming unit 27 is made of a single translucent board 29 such as an acrylic board, which extends in a direction substantially perpendicular to a direction in which the picture light is emitted. On the back surface of the translucent board 29 lies a film screen for back projection, and on the back surface of the film screen lies a film-like fullness lens. Further, the image forming unit 27 and the projector 24 compose a display unit.

Moreover, an image-taking unit 30 such as a camera is arranged above the image forming unit 27. The image-taking unit 30 captures an image of a space facing the image forming unit 27 on a real-time basis and generates image data (motion picture data). The image-taking unit 30 includes a camera having an optical system and an image-taking element, and an image-taking control unit that controls the camera. The optical system of the camera faces in such a direction that it is capable of capturing images of persons in front of the image forming unit 27. Further, the image-taking element is an image sensor such as a CCD (charge coupled device) and a CMOS (complementary metal-oxide semiconductor), and converts optical images having passed through the optical system into two-dimensional image signals. The image-taking unit 30 functions as not only an image-taking unit but also an acquisition unit.

Further, above the image forming unit 27 is a voice input unit 34 that converts voices into electrical signals and inputs the signals. The voice input unit 34 is formed of, for example, a microphone array having a plurality of unidirectional (cardioid-characteristic) microphones arranged in a circular pattern like a ring with the image-taking unit 30 at the center. The voice input unit 34 functions as an acquisition unit.

The base 28 is provided with a button operational unit 32 and a voice output unit 33 such as a speaker for outputting voice. The image-taking unit 30, the operational unit 32, the voice output unit 33, and the voice input unit 34 are connected to the control unit 23 as shown in FIG. 2.

### [Server Device 4]

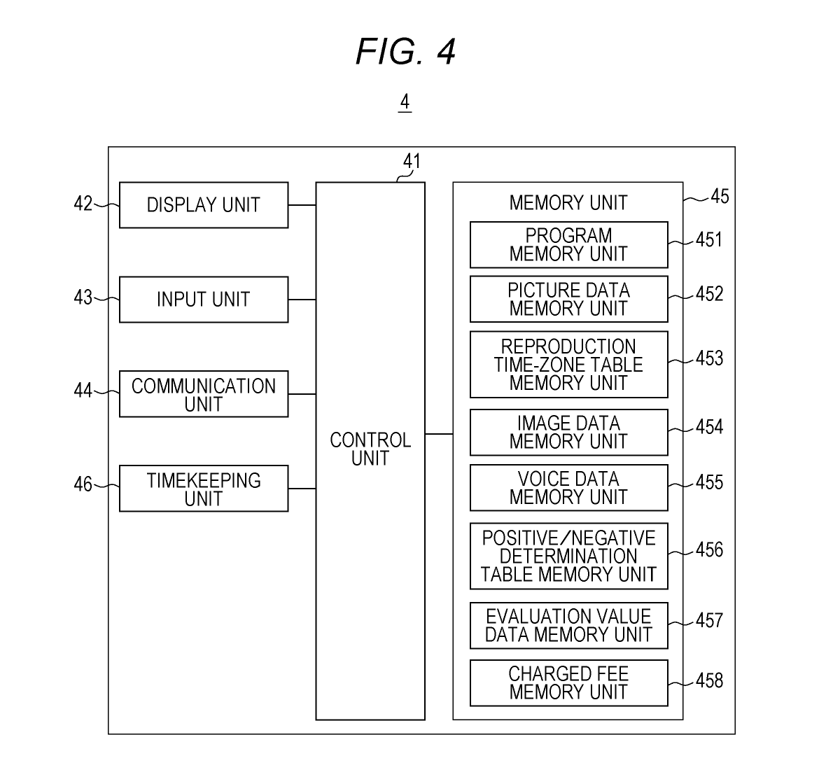

FIG. 4 is a block diagram illustrating a configuration of the main control of the server device 4.

The server device 4 includes a control unit 41, a display unit 42, an input unit 43, a communication unit 44, a memory unit 45, and a timekeeping unit 46. The display unit 42, input unit 43, communication unit 44, memory unit 45, and timekeeping unit 46 are connected to the control unit 41.

The control unit 41 includes a CPU that performs predetermined operations and controls on different units through execution of various programs, and a memory to be a work area at the time of program execution (the CPU and memory not shown in the drawings). The control unit 41 functions as a determination unit, an evaluation value calculation unit, and a fee calculation unit.

The display unit 42 is formed of a LCD (liquid crystal display), for example, and performs various displays according to display information input from the control unit 41.

The input unit 43, which is formed of a keyboard and a pointing device such as a mouse, receives input by an administrator of the server device 4 and outputs the operational information to the control unit 41.

The communication unit 44 includes a modem, a router, a network card, etc. and communicates with external equipment such as the digital signage device 2 on the communication network N.

The memory unit 45 is formed of a HDD (hard disk drive) and a nonvolatile semiconductor memory, for example. The memory unit 45 includes a program memory unit 451, a picture data memory unit 452, and a reproduction time-zone table memory unit 453, an image data memory unit 454, a voice data memory unit 455, a positive/negative determination table memory unit 456, an evaluation value data memory unit 457, a charged fee memory unit 458, etc., as shown in FIG. 4.

The program memory unit 451 stores a system program to be executed in the control unit 41, various processing programs, and data necessary for execution of the programs, for example. The picture data memory unit 452 stores picture data of contents to be reproduced by the digital signage device 2. The reproduction time-zone table memory unit 453 stores, for each content, a table indicating a time period and a time zone where the digital signage device 2 reproduces picture data for the content.

The image data memory unit 454 stores image data received from the digital signage device 2, in a correlation with content ID for identifying a content that was being reproduced when the image data was recorded. The voice data memory unit 455 stores voice data received from the digital signage device 2, in a correlation with content ID for identifying a content that was being reproduced when the voice data was recorded.

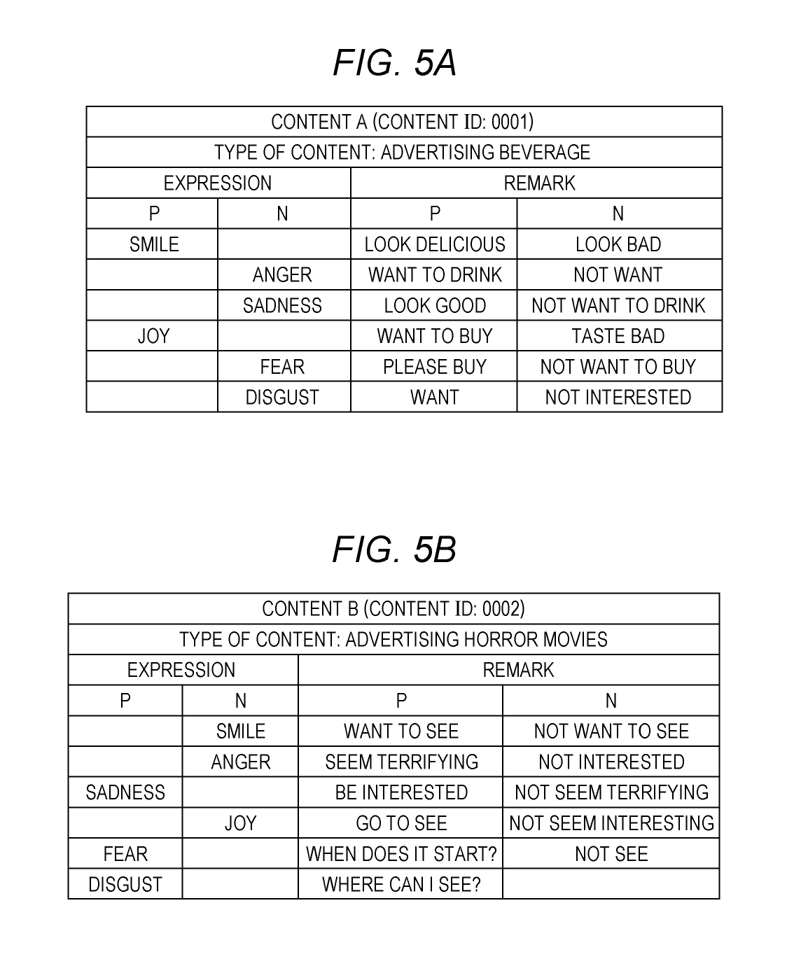

The positive/negative determination table memory unit 456 stores, for each content, a positive/negative determination table storing criteria for positive reactions and negative reactions to the content. FIG. 5A and FIG. 5B each illustrate an example of the positive/negative determination table. As shown in FIGS. 5A and 5B, the positive/negative determination table for each content stores information indicative of elements (facial expressions and remarks) judged as signs of positive reactions (P) to the content and elements (facial expressions and remarks) judged as signs of negative reactions (N) to the content. The remarks are stored in the form of text data.

The “positive” reactions herein refer to actions (for example, facial expressions or remarks) showing positive (affirmative) feelings for a content, and the “negative” reactions herein refer to actions (for example, facial expressions or remarks) showing negative (not-affirmative) feelings for a content.

The criteria for positive reactions and negative reactions differ depending on the substances of contents. For example, in a content A shown in FIG. 5A aiming to advertise beverages, facial expressions of “smile” or “joy” are considered as positive reactions and those of “fear” or “disgust” are considered as negative reactions. In contrast, in a content B aiming to advertise horror movies, facial expressions of “smile” or “joy” are considered as negative reactions and those of “fear” or “disgust” are considered as positive reactions.

The evaluation value data memory unit 457 stores, for each content, data on evaluation values calculated for the content. The charged fee memory unit 458 stores, for each content, a fee to be charged on the advertiser of the content.

The timekeeping unit 46 is formed of a RTC, for example, and acquires information on current date and time and outputs the information to the control unit 23.

### [Operations of Content Charge System 1]

Subsequently, the operations of the content charge system 1 will be described.

When a date and a time come appointed for content reproduction by a table stored in the reproduction time-zone table memory unit 253, the control unit 23 of the digital signage device 2 executes content reproduction control processing, where the control unit 23 reads picture data of a content to be reproduced from the picture data memory unit 252, outputs the image data and voice data of the picture data to the projector 24 and the voice output unit 33, respectively, and reproduces the content in the screen unit 22. Further, the control unit 23 starts execution of reaction acquisition processing described later, in parallel with start of the content reproduction control processing, and records an image and voice of a person who is paying attention to the content being reproduced as reaction information indicating the reactions of the person.

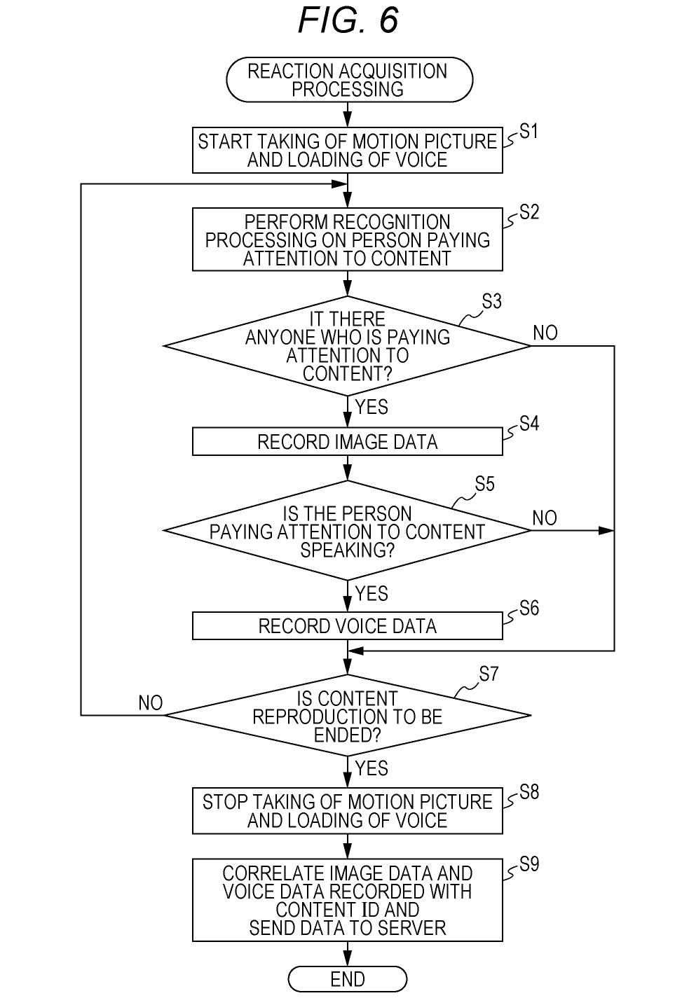

FIG. 6 is a flowchart illustrating the reaction acquisition processing executed by the digital signage device 2. The reaction acquisition processing is executed by cooperative operations of the control unit 23 and the program stored in the program memory unit 251.

First, the control unit 23 activates the image-taking unit 30 and the voice input unit 34 to allow capturing of motion images and loading of voice to be initiated (Step S1).

When the image-taking unit 30 has acquired frame images, the control unit 23 carries out processing for recognizing a person from the frame images who is paying attention to a content being reproduced (Step S2).

The detection (recognition) of a person paying attention to the content being reproduced from the frame images can be made by a publicly-known image processing technique. For example, JP 2011-210238 A discloses a technique of detecting people by: detecting human-body rectangular regions from frame images; specifying the detected human-body rectangular regions as the locations of the people; conducting processing of detecting front facial rectangular regions from the images in the detected human-body rectangular regions; and recognizing, if facial rectangular regions have been detected, the detected facial rectangular regions as the face regions of persons who are paying attention to a content being reproduced.

Any publicly-known method may be used for detecting human-body rectangular regions and facial rectangular regions. For example, for detecting human-body rectangular regions, there can be employed a human body detecting method using Adaboost algorithm that applies HOG (Histogram of Oriented Gradients) features as a weak classifier. On the other hand, for detecting facial rectangular regions, there can be employed a face detecting method using Adaboost algorithm that applies black-and-white Haar-Like features as a weak classifier.

Thereafter, the control unit 23 determines the presence or absence of a person who is paying attention to the content being reproduced, based on the processing results obtained in Step S2 (Step S3).

If the control unit 23 has determined that there is no one who is paying attention to the content being reproduced (“NO” in Step S3), it moves on to the processing in Step S7.

If it has been determined that there exists a person who is paying attention to the content being reproduced (“YES” in Step S3), the control unit 23 correlates the information on the position of the face region recognized in Step S2 with the frame images as added information, and records the information into an image recording region formed in the memory (Step S4).

Next, the control unit 23 determines whether or not the person paying attention to the content being reproduced is speaking (Step S5). Specifically, the control unit 23 prepares a sound pressure map based on signals input from the microphones of the microphone array forming the voice input unit 34, and determines whether or not there is a sound pressure not smaller than a predetermined threshold value in the direction of the face region recorded in Step S3. If having determined that there exists a sound pressure not smaller than the predetermined threshold value in the direction of the detected face region, the control unit 23 concludes that the person paying attention to the content being reproduced is speaking.

If having determined that the person paying attention to the content being reproduced is not speaking (“NO” in Step S5), the control unit 23 moves on to the processing in Step S7.

If having determined that the person paying attention to the content being reproduced is speaking (“YES” in Step S5), the control unit 23 converts voice signals input from the direction of the face region by the voice input unit 34 into voice data, records the voice data into a voice recording region formed in the memory (Step S6), and moves on to the processing in Step S7.

Step S7 determines whether or not the reproduction of the content has ended (Step S7).

If it has been determined that the content reproduction is still continuing (“NO” in Step S7), the control unit 23 goes back to the processing in Step S2 and executes processing from Step S2 to Step S6.

If it has been determined that the content reproduction has ended (“YES” in Step S7), the control unit 23 terminates capturing of motion images by the image-taking unit 30 and voice input by the voice input unit 34 (Step S8). Further, image data (including the added information) and voice data of a series of frame images, which are recorded in the image recording region and the voice recording region in the memory, respectively, are correlated with the content ID, and are sent to the server device 4 by the communication unit 26 (Step S8), so that the reaction acquisition reaction is finished. In the meanwhile, the data in the memory is deleted.

A control unit 41 of the server device 4 correlates image data and voice data with content ID, and stores the data into the image data memory unit 454 and the voice data memory unit 455, respectively, the image data and voice data having been received from the digital signage device 2 by the communication unit 44.

Next, descriptions will be made of the evaluation value calculation processing that the server device 4 performs for calculating an evaluation value for a content based on the image data and the voice data sent from the digital signage device 2.

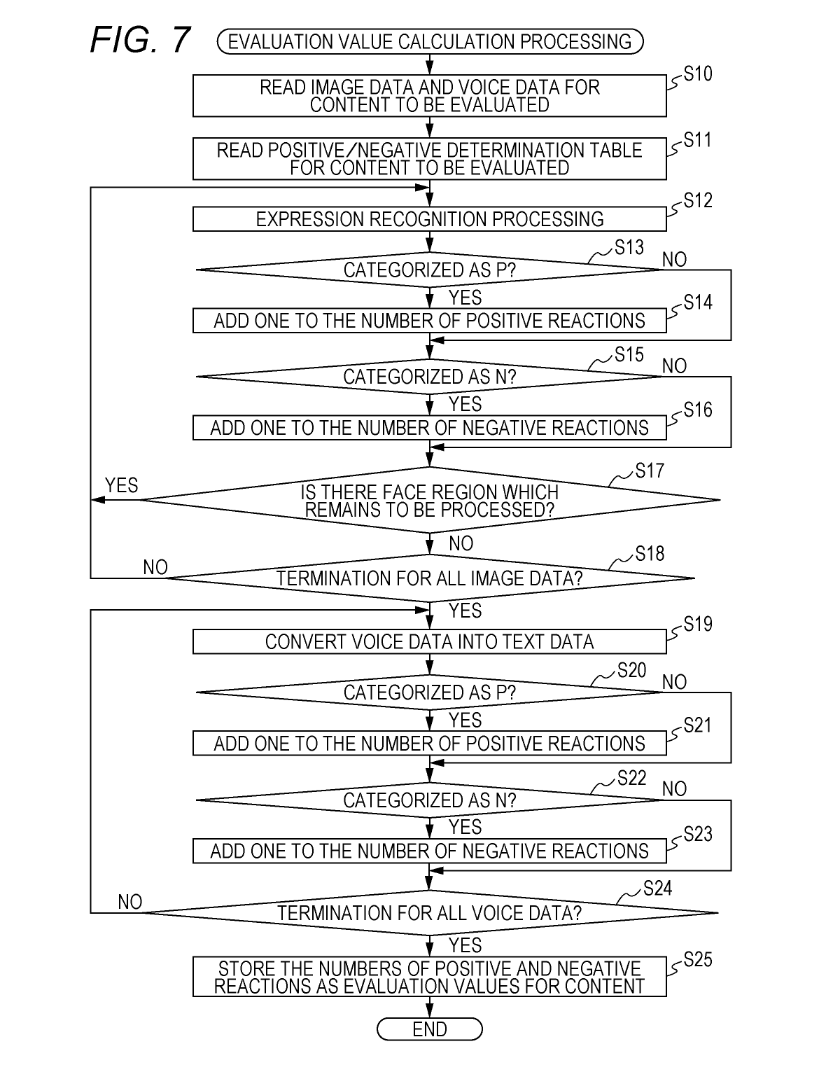

FIG. 7 is a flowchart illustrating the evaluation value calculation processing executed by the server device 4. The calculation processing is carried out by cooperative operations of the control unit 41 and the program stored in the program memory unit 451 at the end of the content reproduction period.

First, the control unit 41 extracts and reads out image data and voice data for the content ID of a content (evaluation target content) for which reproduction period has ended, from the image data memory unit 454 and the voice data memory unit 455, respectively (Step S10). Thereafter, the control unit 41 reads out a positive/negative determination table for the content ID of the evaluation target content from the positive/negative determination table memory unit 456 (Step S11).

Next, the control unit 41 sequentially conducts expression recognition processing on face regions contained in the read image data (frame images) (Step S12). Each frame image has its own information correlated therewith on the position of the face region of a person having paid attention to the content.

The expression recognition processing can be carried out by a publicly-known image processing technique. For example, JP 2011-081445 A discloses a technique of setting focus points around parts of a face region (eyebrows, eyes, nose, mouth) and recognizing expression categories based on the luminance distributions of the set focus points.

Subsequently, the control unit 41 determines whether or not a recognized expression is categorized as P (positive) based on the positive/negative determination table read in Step S11 (Step S13). If it has been determined that the recognized expression is categorized as P (“YES” in Step S13), the control unit 41 adds one to the number of positive reactions in the memory (Step S14) and moves on to the processing in Step S15. In contrast, if it has been determined that the recognized expression is not categorized as P (“NO” in Step S13), the control unit 41 moves on straight to the processing in Step S15.

In Step S15, the control unit 41 determines whether or not a recognized expression is categorized as N (negative) based on the positive/negative determination table read in Step S11 (Step S15). If it has been determined that the recognized expression is categorized as N (“YES” in Step S15), the control unit 41 adds one to the number of negative reactions in the memory (Step S16) and moves on to the processing in Step S17. If it has been determined that the recognized expression is not categorized as N (“NO” in Step S15), the control unit 41 moves on straight to the processing in Step S17.

In Step S17, the control unit 41 determines whether or not there exists any face region that remains to be processed in the frame images as current processing objects (Step S17). If it has been determined that any face region remains to be processed (“YES” in Step S17), the control unit 41 goes back to the processing in Step S12 and executes the processing from Step S12 to Step S16 on the unprocessed face region. If it has been determined that no unprocessed face region exists (“NO” in Step S17), the control unit 41 determines whether or not analysis has been finished for the image data of all the frame images (Step S18). If it has been determined that the analysis has not been finished for the image data (“NO” in Step S18), the processing goes back to Step S12. If it has been determined that the analysis has been finished for the image data (“YES” in Step S18), the control unit 41 moves on to the processing in Step S19.

In Step S19, the control unit 41 performs voice recognition processing on the voice data read in Step S10 and converts the voice data into text data indicating the content of a remark (Step S19).

Next, the control unit 41 checks the text data on the remark against text data for P (positive) in the “remark” section of the positive/negative determination table to determine whether or not the remark falls under the category of P (Step S20). If it has been determined that the remark is categorized as P (“YES” in Step S20), the control unit 41 adds one to the number of positive reactions in the memory (Step S21) and moves on to the processing in Step S22. If it has been determined that the remark is not categorized as P (“NO” in Step S20), the control unit 41 moves on straight to the processing in Step S22.

In Step S22, the control unit 41 checks the text data on the remark against text data for N (negative) in the “remark” section of the positive/negative determination table to determine whether or not the remark falls under the category of N (negative) (Step S22). If it has been determined that the remark is categorized as N (“YES” in Step S22), the control unit 41 adds one to the number of negative reactions in the memory (Step S23) and moves on to the processing in Step S24. If it has been determined that the remark is not categorized as N (“NO” in Step S22), the control unit 41 moves on straight to the processing in Step S24.

In Step S24, the control unit 41 determines whether or not analysis has been finished for all the voice data (Step S24). If it has been determined that the analysis has not been finished for the voice data (“NO” in Step S24), the processing goes back to Step S19. In contrast, if it has been determined that the analysis has been finished for all the voice data (“YES” in Step S24), the control unit 41 moves on to the processing in Step S25.

It should be noted that in Step S20 and Step S22, the text data on the remark and the text data in the table are judged as being in the same category as long as any inconsistency found therebetween at the end of a word or a phrase remains within a predetermined range.

In Step S25, the control unit 41 regards the number of positive reactions in the memory as a positive evaluation value Y with respect to a content to be evaluated, and regards the number of negative reactions in the memory as a negative evaluation value Z with respect to the content, and stores the values Y and Z in the evaluation value data memory unit 457 in a correlation with the content ID of the evaluation target content (Step S25). The evaluation value calculation processing is thus ended.

After the end of the evaluation value calculation processing, the numbers of positive reactions and negative reactions in the memory are cleared.

Moreover, when the server device 4 uses a positive evaluation value alone for calculating a fee to be charged (when charged fee calculation processing A described below is carried out), the evaluation value calculation processing may be conducted in such a manner that determination is made only of whether or not a reaction is categorized as P (positive) and only the number of positive reactions is counted as an evaluation value and is stored in the evaluation value data memory unit 457 in a correlation with content ID. On the other hand, when the server device 4 uses a negative evaluation value alone for calculating a fee to be charged (when charged fee calculation processing B described below is carried out), the evaluation value calculation processing may be conducted in such a manner that determination is made only of whether or not a reaction is categorized as N (negative) and only the number of negative reactions is counted as an evaluation value and is stored in the evaluation value data memory unit 457 in a correlation with content ID.

Thereafter, the charged fee calculation processing will be described, which is processing that the server device 4 performs for calculating a fee to be charged for a content based on an evaluation value obtained for the content.

The charged fee calculation processing to be executed by the server device 4 includes three types of processing A, B, and C. The charged fee calculation processing A, B, and C use a positive evaluation value alone, a negative evaluation value alone, and a combination of a positive evaluation value and a negative evaluation value, respectively, for calculation of a fee to be charged. Which type of the evaluation values is to be employed for the calculation may be determined in the input unit 43 in advance. Hereinafter, the charged fee calculation processing A to C will be described.

First, descriptions will be made of the charged fee calculation processing A using a positive evaluation value alone for calculating a fee to be charged for a content.

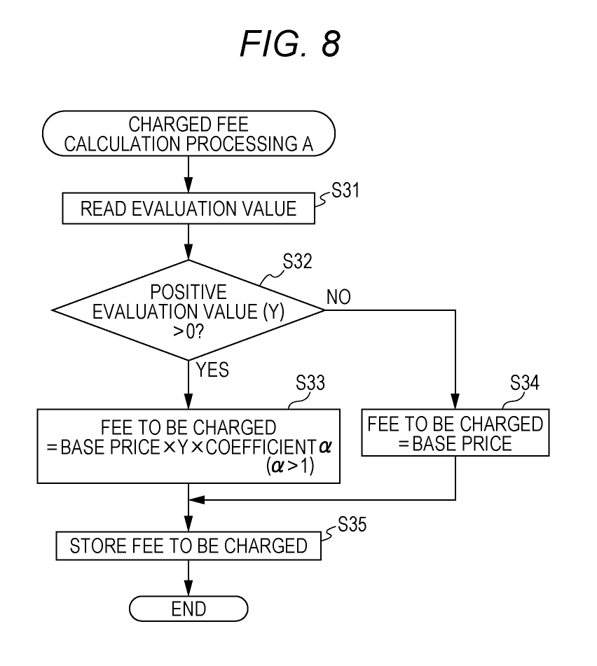

FIG. 8 is a flowchart illustrating the charged fee calculation processing A carried out by the server device 4. The charged fee calculation processing A is executed by cooperative operations of the control unit 41 and the program stored in the program memory unit 451 at the end of the evaluation value calculation processing.

First, the control unit 41 reads evaluation values for the content ID of a content to be charged from the evaluation value data memory unit 457 (Step S31).

Next, the control unit 41 obtains a positive evaluation value (Y) from the evaluation values and determines whether or not Y is larger than 0 (Step S32).

If Y has been determined to be larger than 0 (“YES” in Step S32), the charged fee calculation processing A is given as follows; the control unit 41 calculates an expression, “fee to be charged=previously-fixed base price for advertising rate×Y×coefficient α (α>1)” (Step S33), correlates the obtained fee with the content ID, and stores the fee into the charged fee memory unit 458 (Step S35).

If Y has been determined to be not larger than 0 (“NO” in Step S32), the charged fee calculation processing A is given as follows; the control unit 41 calculates an expression, “fee to be charged=previously-fixed base price for advertising rate” (Step S34), correlates the obtained fee with the content ID, and stores the fee into the charged fee memory unit 458 (Step S35).

Next, descriptions will be made of the charged fee calculation processing B using a negative evaluation value alone for calculating a fee to be charged for a content.

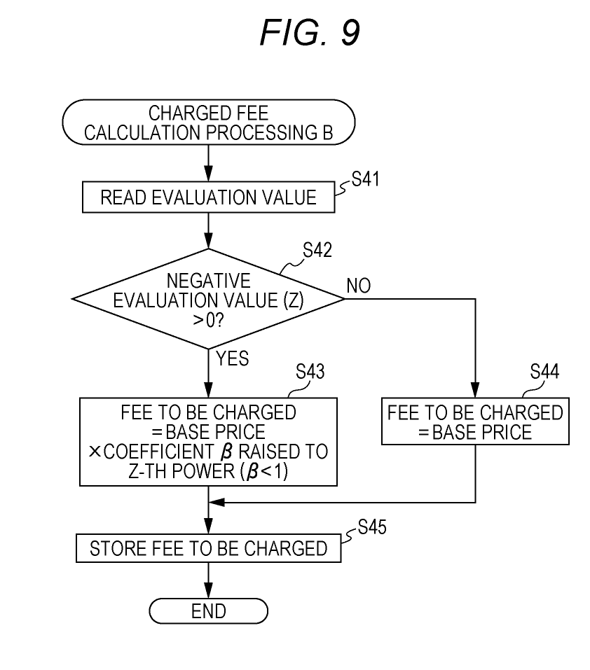

FIG. 9 is a flowchart illustrating the charged fee calculation processing B carried out by the server device 4. The charged fee calculation processing B is executed by cooperative operations of the control unit 41 and the program stored in the program memory unit 451 at the end of the evaluation value calculation processing.

First, the control unit 41 reads evaluation values for the content ID of a content to be charged from the evaluation value data memory unit 457 (Step S41).

Next, the control unit 41 obtains a negative evaluation value (Z) from the evaluation values and determines whether or not Z is larger than 0 (Step S42).

If Z has been determined to be larger than 0 (“YES” in Step S42), the charged fee calculation processing B is given as follows; the control unit 41 calculates an expression, “fee to be charged=previously-fixed base price for advertising rate×coefficient β raised to the Z-th power (β<1)” (Step S43), correlates the obtained fee with the content ID, and stores the fee into the charged fee memory unit 458 (Step S45).

If Z has been determined to be not larger than 0 (“NO” in Step S42), the charged fee calculation processing B is given as follows; the control unit 41 calculates an expression, “fee to be charged=previously-fixed base price for advertising rate” (Step S44), correlates the obtained fee with the content ID, and stores the fee into the charged fee memory unit 458 (Step S45).

Subsequently, descriptions will be made of the charged fee calculation processing C using a combination of a positive and a negative evaluation values for calculating a fee to be charged for a content.

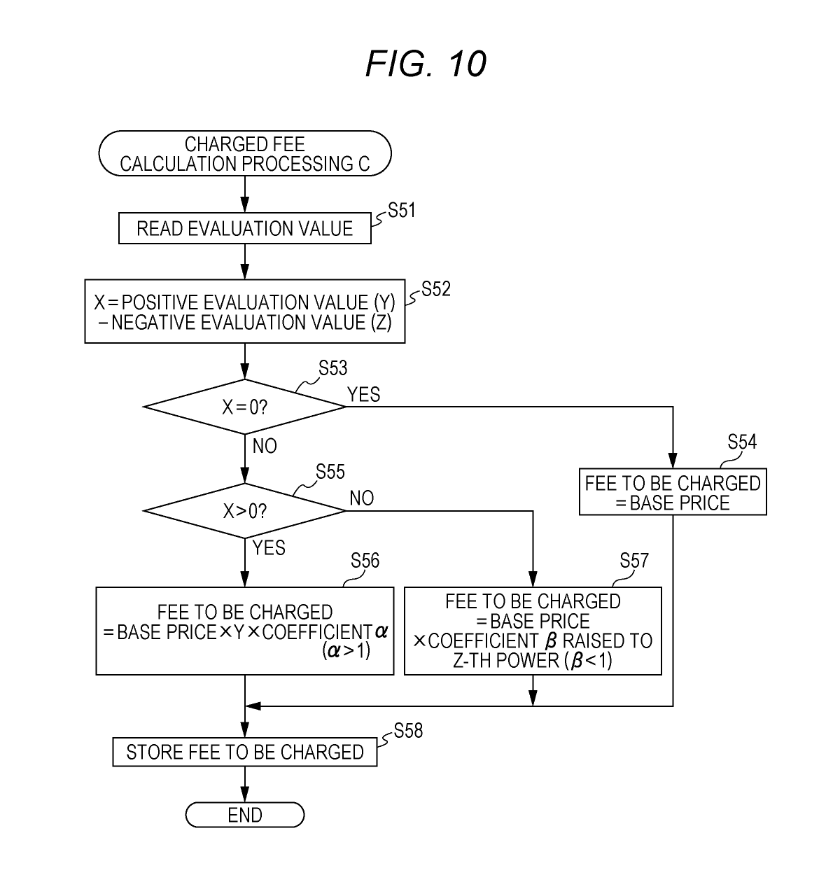

FIG. 10 is a flowchart illustrating the charged fee calculation processing C carried out by the server device 4. The charged fee calculation processing C is executed by cooperative operations of the control unit 41 and the program stored in the program memory unit 451 at the end of the evaluation value calculation processing.

First, the control unit 41 reads evaluation values for the content ID of a content to be charged from the evaluation value data memory unit 457 (Step S51).

Next, the control unit 41 calculates a value (X) to be obtained by subtracting the negative evaluation value (Z) from the positive evaluation value (Y) (Step S52), and determines whether or not X is 0 (Step S53).

If X has been determined to be 0 (“YES” in Step S53), the charged fee calculation processing C is given as follows; the control unit 41 calculates an expression, “fee to be charged=previously-fixed base price for advertising rate” (Step S54), correlates the obtained fee with the content ID, and stores the fee into the charged fee memory unit 458 (Step S58). On the other hand, if X has been determined to be not 0 (“NO” in Step S53), the control unit 41 moves on to Step S55.

In Step S55, the control unit 41 determines whether or not X is larger than 0 (Step S55).

If X has been determined to be larger than 0 (“YES” in Step S55), the charged fee calculation processing C is given as follows; the control unit 41 calculates an expression, “fee to be charged=previously-fixed base price for advertising rate×Y×coefficient α (α>1)” (Step S56), correlates the obtained fee with the content ID, and stores the fee into the charged fee memory unit 458 (Step S58).

If X has been determined to be not larger than 0 (“NO” in Step S55), the charged fee calculation processing C is given as follows; the control unit 41 calculates an expression, “fee to be charged=previously-fixed base price for advertising rate×coefficient β raised to the Z-th power (β<1)” (Step S57), correlates the obtained fee with the content ID, and stores the fee into the charged fee memory unit 458 (Step S58).

According to the content charge system 1 of the embodiment, in the digital signage device 2, the control unit 23 recognizes a person who is paying attention to a content based on an image of a person in front of the image forming unit 27 captured by the image-taking unit 30 during reproduction of the content, the image-taking unit 30 and the voice input unit 34 respectively acquire image data and voice data of the person paying attention to the content as reaction information indicating reactions of the person, and the communication unit 26 sends the data to the server device 4, as described above. The control unit 41 of the server device 4 analyzes the image data and voice data when the communication unit 44 receives the image data and the voice data from the digital signage device 2, and determines whether the person paying attention to the content has reacted in a positive manner or a negative manner to the content. Thereafter, the control unit 41 counts the number of determinations that a reaction to the content is categorized as positive and/or the number of determinations that a reaction to the content is categorized as negative, so that it calculates evaluation values for the content.

By thus evaluating a content by the number of positive reactions and/or negative reactions that people paying attention to the content, in other words, viewers of the content have given, the present invention makes it possible to precisely evaluate a content in consideration of influences of the content on the viewers (effects of the content).

Specifically, the control unit 41 recognizes the expression of a person paying attention to a content based on image data of the person, and determines whether the recognized expression is categorized as positive or negative about the content. This makes it possible to precisely evaluate a content based on the expressions of viewers of the content.

Further, the control unit 41 recognizes a remark of a person paying attention to a content based on the voice of the person, and determines whether the recognized remark suggests a positive reaction or a negative reaction to the content. This makes it possible to precisely evaluate a content based on the remarks of viewers of the content.

Moreover, it becomes possible to evaluate a content in accordance with appropriate criteria varying depending on the substance of the content, since the control unit 41 uses a positive/negative determination table corresponding to a content for determining whether a reaction to the content is categorized as positive or negative about the content, a positive/negative determination table being stored on a content-by-content basis in the memory unit 45 of the server device 4 and storing criteria for positive reactions and negative reactions to a content.

In addition, it becomes possible to set an appropriate price for a content reflecting the influence of the content on viewers, since the control unit 41 of the server device 4 calculates a fee to be charged for a content based on a calculated evaluation value.

It should be noted that the above descriptions of the embodiment are only of a preferred example of the content charge system according to the present invention and that the present invention is not limited to this example.

For example, although the embodiment uses both of the image and the voice of a person paying attention to a content in order to acquire reactions of the person, either one of them is sufficient for acquiring the reactions.

Further, although it is the control unit 41 of the server device 4 that carries out the evaluation value calculation processing and charged fee calculation processing (A to C) in the embodiment, it may be the control unit 23 of the digital signage device 2. In other words, the display unit, image-taking unit, recognition unit, acquisition unit, determination unit, evaluation value calculation unit, and charged fee calculation unit may be all included in the digital signage device 2.

Moreover, although a content is in the form of picture in the embodiment, it may be in the form of still image, for example.

Furthermore, alterations may occur as appropriate on the details of the configurations and/or operations of the units of the content charge system insofar as they are within the scope of the gist of the invention.

Although some embodiments of the present invention have been described, the claimed invention is not limited to these embodiments and includes the inventions disclosed in the claims and the equivalents thereof.

The following is the invention disclosed in the claims originally attached to the request of the present application. The numbering of the claims appended is the same as the numbering of the claims originally attached to the request of the application.

What is claimed is:

1. An information processor, comprising:
a display unit configured to display a content;
an image-taking unit configured to take an image of a person who is in front of the display unit during display of the content;
a recognition unit configured to recognize a person who is paying attention to the content based on the image captured by the image-taking unit;
an acquisition unit configured to acquire reaction information indicating a reaction of the person paying attention to the content;
a determination unit configured to determine whether the reaction of the person paying attention to the content is categorized as positive or negative about the content, based on the reaction information; and
a fee calculation unit configured to calculate a fee to be charged for the content by counting the number of determinations made by the determination unit that a reaction to the content is categorized as positive or negative about the content.

2. The information processor according to claim 1, wherein
the acquisition unit is configured to acquire the image captured by the image-taking unit of the person paying attention to the content, as the reaction information, and
the determination unit is configured to recognize an expression of the person paying attention to the content based on the image of the person and determine whether the recognized expression is categorized as a positive reaction or a negative reaction to the content.

3. The information processor according to claim 1, further comprising a voice input unit, wherein
the acquisition unit is configured to acquire voice input by the voice input unit of the person paying attention to the content, as the reaction information, and
the determination unit is configured to recognize a remark of the person paying attention to the content based on the voice of the person and determine whether the recognized remark suggests a positive reaction or a negative reaction to the content.

4. The information processor according to claim 2, further comprising a voice input unit, wherein
the acquisition unit is configured to acquire voice input by the voice input unit of the person paying attention to the content, as the reaction information, and
the determination unit is configured to recognize a remark of the person paying attention to the content based on the voice of the person and determine whether the recognized remark suggests a positive reaction or a negative reaction to the content.

5. The information processor according to claim 1, wherein the determination unit is configured to apply a criterion varying depending on the substance of the content, to the determination of whether the reaction is categorized as positive or negative about the content.

6. The information processor according to claim 2, wherein the determination unit is configured to apply a criterion varying depending on the substance of the content, to the determination of whether the expression is categorized as a positive reaction or a negative reaction to the content.

7. The information processor according to claim 3, wherein the determination unit is configured to apply a criterion varying depending on the substance of the content, to the determination of whether the remark suggests a positive reaction or a negative reaction to the content.

8. The information processor according to claim 4, wherein the determination unit is configured to apply a criterion varying depending on the substance of the content, to the determination of whether the remark suggests a positive reaction or a negative reaction to the content.

9. An information processing method, comprising the steps of:
displaying a content;
taking an image of a person who is in front of a display unit during display of the content;
recognizing a person who is paying attention to the content, based on the image obtained by the image-taking step;
acquiring reaction information indicating a reaction of the person paying attention to the content;
determining whether the reaction of the person paying attention to the content is categorized as positive or negative about the content, based on the reaction information; and
calculating a fee to be charged for the content by counting the number of determinations made by the determination step that a reaction to the content is categorized as positive or negative.

10. A computer readable medium for use in an information processor, the information processor including a display unit configured to display a content and an image-taking unit configured to take an image of a person who is in front of the display unit during display of a content,
the computer readable medium storing a program causing a computer to execute:
image-taking processing of taking an image of a person who is in front of the display unit during display of a content;
recognition processing of recognizing a person who is paying attention to the content based on the captured image obtained by the image-taking processing;
acquisition processing of acquire reaction information indicating a reaction of the person paying attention to the content;
determination processing of determining whether the reaction of the person paying attention to the content is categorized as positive or negative about the content, based on the reaction information obtained by the acquisition processing; and
fee calculation processing of calculating a fee to be charged for the content by counting the number of determinations made by the determination processing that a reaction to the content is categorized as positive or negative about the content.
